(19) United States
(12) Patent Application Publication
(10) Pub. No.: US 2006/0125141 A1
(43) Pub. Date: Jun. 15, 2006

(54) Method for continuously manufacturing anti-sliperry chopping boards

(75) Inventor: Cheng-Che Hsieh, Tainan City (TW)

Correspondence Address: TROXELL LAW OFFICE PLLC, SUITE 1404, 5205 LEESBURG PIKE, FALLS CHURCH, VA, 22041, US

(73) Assignee: Tsau Ju International Ltd.

(21) Appl. No.: 11/011,101

(22) Filed: Dec. 15, 2004

(51) Int. Cl. B29C 37/00

(52) U.S. Cl. 264/160; 264/210.1

(57) ABSTRACT

A method for continuously manufacturing anti-slippery chopping boards, and the method uses a bottom mold pressing machine to provide a plastic mold board from the material output mold; the plastic mold board goes through a set of rollers for setting its thickness and is fed to the bottom of the mouth of an anti-slippery material pressing mold with the same width the after a preliminary setting is completed; a fixed-distance scraping board disposed at a material output position on a material transporting roller is used to produce rectangular anti-slippery meshes on the manufactured sheet anti-slippery material by intermittent scraping, so that the anti-slippery meshes can be formed and attached onto the surface of the plastic mold board simultaneously, while the plastic mold board is still not completely solidified. The finished good of the anti-slippery pad is seemingly an integral structure with one layer. After the plastic mold board and the anti-slippery mesh are integrally combined by the follow-up rollers, a thin pad with an anti-slippery bottom surface serving as a temporary chopping board is produced by cutting the plastic mold board into a fixed size, or the anti-slippery material is transferred onto the top surface or the bottom surface of the pad to produce an anti-slippery plastic mold board or an anti-slippery mesh placemat as to achieve a simple, convenient and cost-effective manufacturing process.

### BACKGROUND OF THE INVENTION

1. Field of the Invention

This invention relates to a method for continuously manufacturing anti-slippery chopping boards, and the method comprises the steps of using the continuous manufacturing process of a plastics pressing machine to provide a plastic mold board from the mouth of a first material output mold; continuing to feed the plastic mold board to the bottom of the mouth of a second material output mold after a preliminary setting is completed; using a fixed-distance scraping board disposed at a material output position on a material transporting roller to continuously produce sheets of anti-slippery materials on the rectangular anti-slippery meshes on the surface of the plastic mold board as to manufacture a thin pad having an anti-slippery bottom surface or an anti-slippery top surface for providing a chopping board or transferring the pad surface to provide an anti-slippery product with a simple and easy manufacturing process.

2. Description of the Related Art

In general, thin plastic pads are used for making placemats or serving as a temporary chopping board. The thin plastic pad is easy-to-wash and sanitary, and its price is low and would not cost much if we discard them after its use. However, the traditional plastic pads for this application generally have an S-shaped pattern printed on or transferred to their surface for the purpose of artistic look. A flat pad 2 as shown in FIG. 1 is produced after performing the cutting process. Since the surface (either the top surface or the bottom surface) of such pad is very smooth, therefore the object placed on it will slide or turn over easily. Many manufacturers use a partial melting method or a pasting method to add an anti-slippery plastic layer 21 in form of dots, faces, or lumps on the bottom surface of the pad 2 after the manufacture of the plastic pad 2 is completed in order to provide the anti-slippery effect. Such post-manufacturing process not only causes inconvenience and increases manufacturing costs, but also increases the selling price of such anti-slippery placemats or chopping boards (even no pattern is printed on the surface). Consumers carry extra costs for no reason and thus will hesitate to buy such products. More importantly, the post-manufacturing process is performed after the plastic pad has been manufactured. In other words, the thin layer on the plastic pad is solidified completely and its physical conditions are stable, such that another substance (such as the anti-slippery layer) cannot be attached onto it easily. Therefore, even the anti-slippery layer can be pasted onto the surface of the manufactured pad, it will come off or part of it will be peeled after being used for a while or rubbed in its use. Besides the drawback of its appearance, the intended anti-slippery function is lost, which is the major drawback of the traditional anti-slippery pad manufacturing process.

In view of the foregoing drawbacks of the traditional manufacturing process, the inventor of the present invention conducted extensive researches and experiments. and finally invented a continuous manufacturing process that comprises the formation of an anti-slippery layer, color printing and pressing manufacture.

### SUMMARY OF THE INVENTION

The primary objective of this invention is to provide a method for continuously manufacturing anti-slippery chopping boards, and the method uses a bottom mold pressing machine to provide a plastic mold board from the material output mold; the plastic mold board goes through a set of rollers for setting its thickness and is fed to the bottom of the mouth of an anti-slippery material pressing mold with the same width, after a preliminary setting is completed; a fixed-distance scraping board disposed at a material output position on a material transporting roller is used to produce rectangular anti-slippery meshes on the manufactured sheet anti-slippery material by an intermittent scraping method, so that the anti-slippery meshes can be formed and attached onto the surface of the plastic mold board simultaneously, while the plastic mold board is still not completely solidified. The finished good of the anti-slippery pad is seemingly an integral structure with one layer. Therefore, the finished goods of the present invention have outstanding securing effects, and the anti-slippery layer will not fall off or partially peeled during its use, and thus having a durable feature.

The secondary objective of the present invention is to provide a method for continuously manufacturing anti-slippery chopping boards, which uses the continuous manufacturing process of a plastic pressing machine to provide a plastic mold board from the mouth of material output mold, and continues to feed the plastic mold board to the bottom of the mouth of a second material output mold after a preliminary setting is completed, and uses a fixed-distance scraping board disposed at a material output position on a material transporting roller to continuously produce sheets of anti-slippery materials on the rectangular anti-slippery meshes on the surface of the plastic mold board. After the plastic mold board and the anti-slippery mesh are integrally combined by the follow-up rollers, a thin pad with an anti-slippery bottom surface serving as a chopping board is produced by cutting the plastic mold board into a fixed size, or the anti-slippery material is transferred onto the top surface or the bottom surface of the pad to produce an anti-slippery plastic mold board or an anti-slippery mesh placemat. The present invention is applicable for the continuous automatic mass production and thus can lower production costs and the attrition rate of the manufacturing process as to provide consumers an economic and reasonable priced anti-slippery chopping board.

### BRIEF DESCRIPTION OF THE DRAWINGS

Other features and advantages of the present invention will become apparent in the following detailed description of the preferred embodiments with reference to the accompanying drawings, in which:

FIG. 1 is a view of a pad according to a prior art.

FIG. 2 is a perspective view of the manufacturing process according to the present invention.

FIG. 3A is a top view of the manufacturing process according to the present invention.

FIG. 3B is a side view of the manufacturing process according to the present invention.

FIG. 4 is a perspective view of a finished good according to the present invention.

FIG. 4A is an enlarged view of part of FIG. 4.

FIG. 5 is a perspective view of another finished good according to the present invention.

FIG. 5A is an enlarged view of part of FIG. 5.

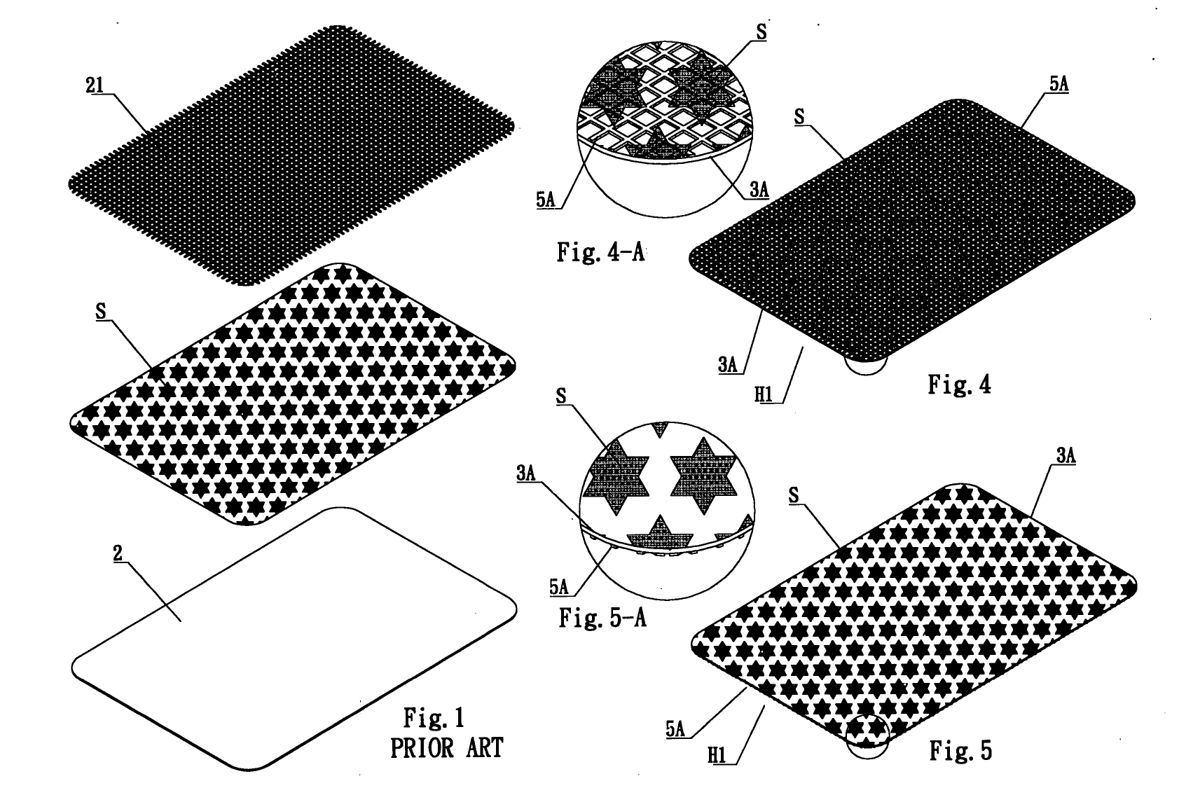

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

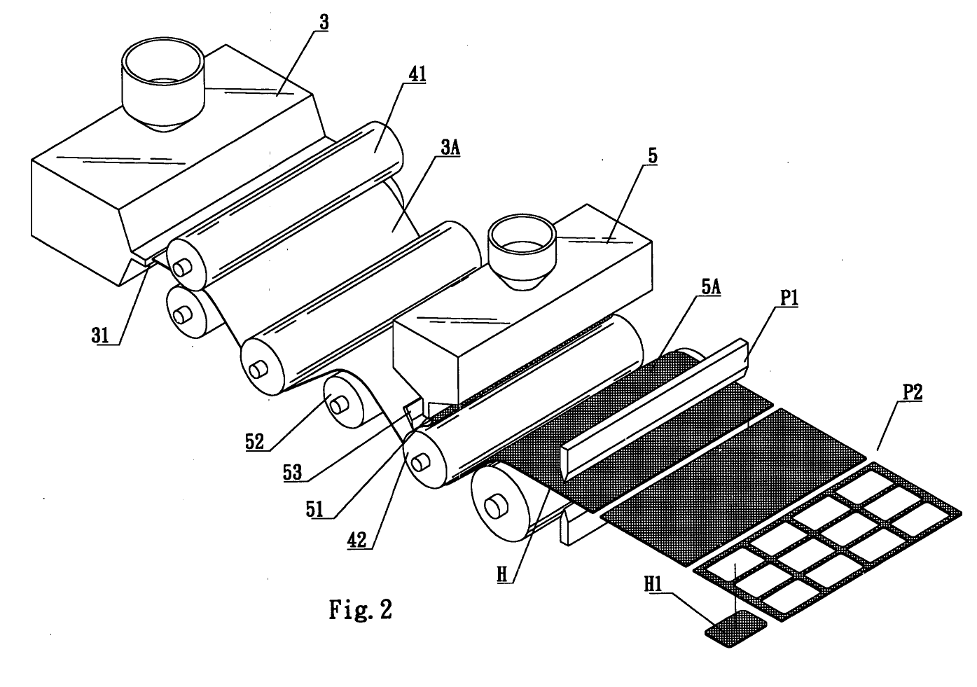

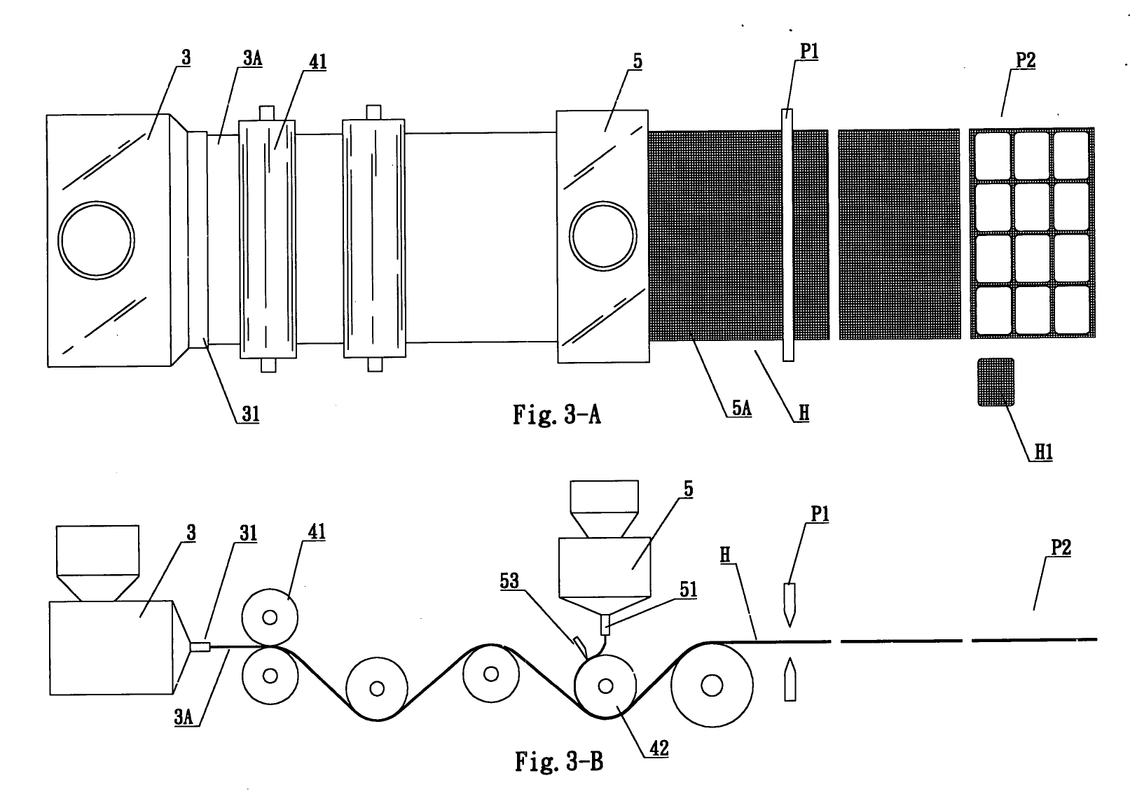

Please refer to FIGS. 2, 3A and 3B for the manufacturing process and the features of the product in accordance with the present invention. The method for manufacturing anti-slippery chopping boards comprises the steps of providing a plastic mold board 31A from the mouth of a first material output mold 31 of a first bottom mold pressing machine 3; and continuing to feed the plastic mold board 31A to the bottom of the mouth of a second material output mold 51 after going through a plurality of pressing rollers 41 for a preliminary setting of its thickness and being fed to the bottom of the mouth of a second anti-slippery material pressing machine 5 with the same width; using a fixed-distance scraping board 53 disposed at a material output position in front of a material transporting roller 52 at the mold mouth 51 of said anti-slippery material pressing machine 5 to continuously provide said sheet anti-slippery material by an intermittent scraping method to produce a plurality of rectangular anti-slippery meshes 5A, such that the anti-slippery meshes 5A are attached onto the surface of the plastic mold board 3A before being completely solidified; forming a continuous pad H with two different plastic layers after the plastic mold board 3A and the anti-slippery mesh 5A are coupled integrally by a follow-up roller 42 and cooled; and producing a thin anti-slippery pad H1 having an anti-slippery bottom surface after cutting the plastic mold board 3A into a fixed size by using a fixed length cutting device P1 and a fixed size trimming device P2. Besides serving as a chopping board, the anti-slippery pad H1 could also serve as a placemat by printing a S-shape pattern on the top surface or the bottom surface of the anti-slippery pad H1 having the anti-slippery plastic mold board 3A on its surface (as shown in FIGS. 4 and 4A) or the anti-slippery mesh 5A (as shown in FIGS. 5 and 5A).

What is claimed is:

1. A method for continuously manufacturing anti-slippery chopping boards, comprising the steps of:
providing a plastic mold board from the mouth of a first material output mold of a first bottom mold pressing machine; and
continuing to feed said plastic mold board to the bottom of the mouth of a second material output mold after going through a plurality of pressing rollers for a preliminary setting of its thickness and being fed to the bottom of the mouth of a second anti-slippery material pressing machine with the same width;
using a fixed-distance scraping board disposed at a material output position in front of a material transporting roller of said anti-slippery material pressing machine to continuously provide said sheet anti-slippery material by an intermittent scraping method to produce a plurality of rectangular anti-slippery meshes, such that said anti-slippery meshes are attached onto the surface of said plastic mold board before being solidified completely;
forming a continuous pad with two different plastic layers after said sheet anti-slippery material and said plastic mold board are coupled integrally by a follow-up roller and is cooled; and
producing a thin anti-slippery pad having an anti-slippery bottom surface after cutting said plastic mold board into a fixed size by using a fixed length cutting device and a fixed size trimming device.

2. The method for continuously manufacturing anti-slippery chopping boards of claim 1, wherein said thin anti-slippery pad having an anti-slipper bottom surface comprises a pattern selectively printed on a top surface and a bottom surface of said anti-slippery pad for producing a placemat selectively having an anti-slippery plastic mold board and an anti-slippery mesh surface.
